(19) United States
(12) Patent Application Publication
(10) Pub. No.: US 2026/0089197 A1
(43) Pub. Date: Mar. 26, 2026

(54) SYSTEMS AND METHODS FOR DIGITAL SHARED CONNECTIONS SPACES

(71) Applicant: Google LLC, Mountain View, CA (US)

(72) Inventors: Pablo Federico Majernik, Sammamish, WA (US); Ricardo Paz, San Jose, CA (US); Evan Smithers, Portland, OR (US); Juan Carlos Angustia Garcia, Philadelphia, PA (US); Kimberly Ha, Seattle, WA (US); Humberto Castaneda, Kirkland, WA (US)

(21) Appl. No.: 18/891,164

(22) Filed: Sep. 20, 2024

(51) Int. Cl. H04L 65/403; G06F 3/0481; H04L 12/18; H04L 65/1089

(52) U.S. Cl. CPC H04L 65/403; H04L 12/1818; H04L 65/1089; G06F 3/0481

(57) ABSTRACT

A method for digital shared connections spaces includes causing a collaborative visual space to be presented to one or more participants of a shared connections space. The collaborative visual space includes one or more images each representing a media item. The method includes receiving, from a first client device of a first participant, a first media item and an indication of a location of the first media item in the collaborative visual space. The method includes causing an image of the first media item to be added to the collaborative visual space at the indicated location. The method includes, responsive to a second client device of a second participant accessing the image of the first media item, causing the first media item to perform an action in the collaborative visual space presented on the second client device.

### TECHNICAL FIELD

Aspects and implementations of the present disclosure relate to virtual meetings and more specifically to digital shared connections spaces.

### BACKGROUND

Virtual meetings can take place between multiple participants via a virtual meeting platform. A virtual meeting platform can include tools that allow multiple client devices to be connected over a network and share each other's audio (e.g., voice of a user recorded via a microphone of a client device) and/or video stream (e.g., a video captured by a camera of a client device, or video captured from a screen image of the client device) for efficient communication. To this end, the virtual meeting platform can provide a user interface that includes multiple regions to present the video stream of each participating client device.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a method for digital shared connections spaces. The method includes causing, by a shared connections space platform, a collaborative visual space to be presented to one or more participants of a shared connections space. The collaborative visual space may include one or more images each representing a media item. The method includes receiving, from a first client device of a first participant of the one or more participants of the shared connections space, a first media item and an indication of a location of the first media item in the collaborative visual space. The method includes causing an image of the first media item to be added to the collaborative visual space at the indicated location. The method includes, responsive to a second client device of a second participant of the one or more participants accessing the image of the first media item, causing the first media item to perform an action in the collaborative visual space presented on the second client device of the second participant.

Another aspect of the disclosure provides a system. The system includes a memory and a processing device coupled to the memory. The processing device is configured to perform operations. The operations include causing, by a shared connections space platform, a collaborative visual space to be presented to one or more participants of a shared connections space. The collaborative visual space may include one or more images each representing a media item. The operations include receiving, from a first client device of a first participant of the one or more participants of the shared connections space, a first media item and an indication of a location of the first media item in the collaborative visual space. The operations include causing an image of the first media item to be added to the collaborative visual space at the indicated location. The operations include, responsive to a second client device of a second participant of the one or more participants accessing the image of the first media item, causing the first media item to perform an action in the collaborative visual space presented on the second client device of the second participant.

Another aspect of the disclosure provides a non-transitory computer-readable storage medium including instructions that, when executed by a processing device, cause the processing device to perform operations. The operations include causing, by a shared connections space platform, a collaborative visual space to be presented to one or more participants of a shared connections space. The collaborative visual space may include one or more images each representing a media item. The operations include receiving, from a first client device of a first participant of the one or more participants of the shared connections space, a first media item and an indication of a location of the first media item in the collaborative visual space. The operations include causing an image of the first media item to be added to the collaborative visual space at the indicated location. The operations include, responsive to a second client device of a second participant of the one or more participants accessing the image of the first media item, causing the first media item to perform an action in the collaborative visual space presented on the second client device of the second participant.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture for digital shared connections spaces, in accordance with some implementations of the present disclosure.

FIG. 2 depicts a flow diagram of a method for digital shared connections spaces, in accordance with some implementations of the present disclosure.

FIG. 3 depicts a user interface (UI) displaying a visual collaboration space of a shared connections space, in accordance with some implementations of the present disclosure.

FIG. 4 depicts another UI displaying a visual collaboration space of a shared connections space, in accordance with some implementations of the present disclosure.

FIG. 5 depicts another UI displaying a visual collaboration space of a shared connections space, in accordance with some implementations of the present disclosure.

FIG. 6 depicts another UI displaying a visual collaboration space of a shared connections space, in accordance with some implementations of the present disclosure.

FIG. 7 depicts a UI for a virtual meeting launched from a shared connections space, in accordance with some implementations of the present disclosure.

FIG. 8 is a block diagram illustrating an example computer system, in accordance with some implementations of the present disclosure.

### DETAILED DESCRIPTION

Aspects of the present disclosure relate to systems and methods for digital shared connections spaces. A virtual meeting platform can enable video-based conferences between multiple participants via respective client devices that are connected over a network and share each other's audio (e.g., voice of a user recorded via a microphone of a client device) and/or video streams (e.g., a video captured by a camera of a client device) during a virtual meeting. In some instances, a virtual meeting platform can enable a significant number of client devices (e.g., up to one hundred or more client devices) to be connected via the virtual meeting. A participant of a virtual meeting can speak to the other participants of the virtual meeting. Some existing virtual meeting platforms can provide a user interface (UI) to each client device connected to the virtual meeting, where the UI displays visual items corresponding to the video streams shared over the network in a set of regions in the UI.

In a typical virtual meeting, participants can share documents, files, or other data with each other during the virtual meeting. This may include a first participant sharing the participant's screen to show a slide presentation or the first participant providing a link to a document stored in cloud storage in a text chat of the virtual meeting UI. However, participants sharing data during a virtual meeting can only use a limited number of predetermined formats (screen sharing, sharing data via a text chat, etc.). Furthermore, the shared data is only available for viewing or access by participants during the virtual meeting. For example, after the virtual meeting concludes, screen sharing is no longer available, and the text chat (including messages where a participant has shared data) does not persist.

Implementations of the present disclosure address the above and other deficiencies by providing a shared connections space platform that allows users to use a shared connection space. The shared connections space refers to a collaborative visual space that includes media items, which are added by participants of the shared connections space and which can be viewed by and interacted with other participants of the shared connections space. The media items can include images, audio, videos, software code, documents, links to web resources, or any other content items. The collaborative visual space can act like a bulletin board where participants can add media items, spatially rearrange the media items, and interact with the media items (e.g., play a video, view an image, listen to audio). The shared connections space can include a theme indicated by colors, fonts, or other visual data that provides aesthetics specific to the shared connections space. The collaborative visual space persists even when no participants of the shared connections space are connected to the shared connections space.

The shared connections space can also include a text chat where participants currently connected to the shared connections space can send each other text-based messages in the shared connections space. The shared connections space can also include an audio chat where a participant can stream audio to the shared connections space, and other participants connected to the shared connections space can hear the audio. The shared connections space can also launch a virtual meeting for participants currently connected to the shared connections space.

Aspects and implementations of the present disclosure provide a shared connections space platform that allows participants to use a shared connections space as a dedicated, informal space to share media items, connect with each other, and collaborate. Because the shared connections space persists even when participants are not currently connected, participants can interact with each other on their own time, providing media items to the visual collaboration space for later use by other participants. As a result, computing resources otherwise needed to allow users to locate media items of interest are no longer consumed.

Aspects of the present disclosure provide technical advantages over previous solutions. One technical problem includes unnecessary consumption of computing resources due to the limited ways by which participants of a virtual meeting share documents and other data. Aspects of the present disclosure provide a technical solution by providing a shared connections space where participants can visually share documents and other data beyond the predefined formats of a virtual meeting so the data can be accessed by multiple participants in a visual manner. Another technical problem related to virtual meetings includes the documents and other data shared during a virtual meeting not persisting after the conclusion of the virtual meeting. Aspects of the present disclosure provide a technical solution by providing a shared connections space where documents and other information remain in a collaborative visual space even when other participants of the shared connections space are not currently accessing the space. Thus, the aspects and implementations of the present disclosure enhance the experience of virtual meeting participants.

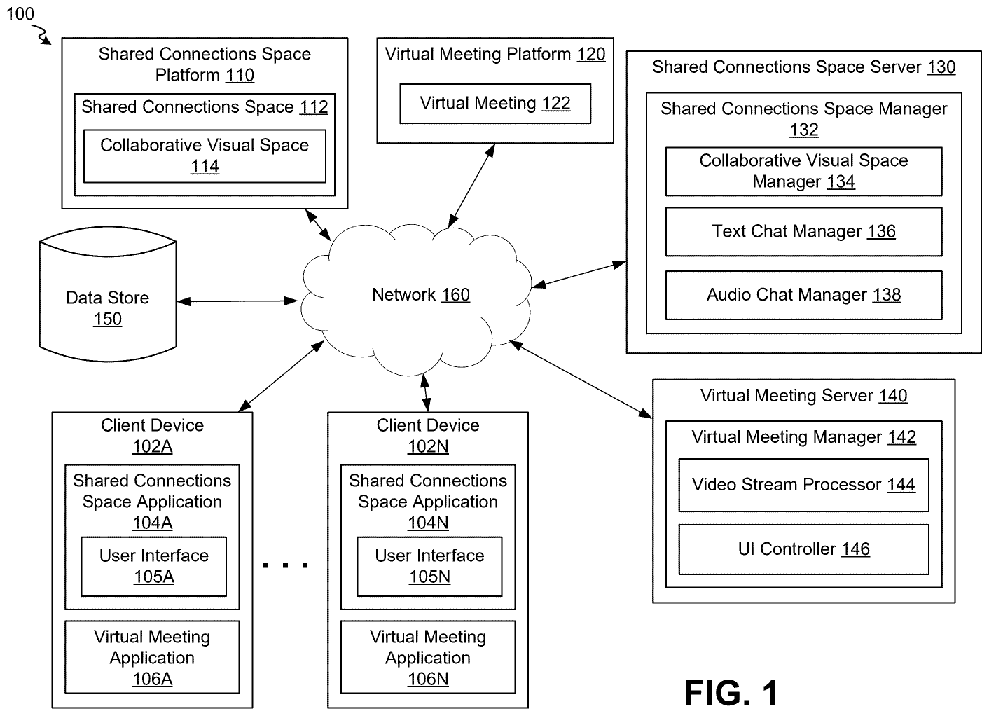

FIG. 1 illustrates an example system architecture 100, in accordance with implementations of the present disclosure. The system architecture 100 includes one or more client devices 102A-N, a shared connections space platform 110, a virtual meeting platform 120, a shared connections space server 130, a virtual meeting server 140, and a data store 150, each connected to a network 160.

In some implementations, the shared connections space platform 110 enables users of one or more of the client devices 102A-N to participate in a shared connections space (e.g., a shared connections space 112). A shared connections space 112 refers to a digital space where users of the one or more client devices 102A-N (referred to herein as “participants”) can add one or more media items for viewing or access by participants of the shared connections space 112. The shared connections space 112 may include a collaborative visual space 114. The collaborative visual space 114 may include a graphical UI that includes images corresponding to the media items. A participant of the shared connections space may view the collaborative visual space 114 on a client device 102A-N, interact with the one or more media items of the collaborative visual space 114, or add a media item to the collaborative visual space 114.

In implementations of the disclosure, a “user” or “participant” can be represented as a single individual. However, other implementations of the disclosure encompass a “user” being an entity controlled by a set of users or an organization and/or an automated source such as a system or a platform. In situations in which the systems discussed here collect personal information about users, or can make use of personal information, the users can be provided with an opportunity to control whether the shared connections space platform 110, the virtual meeting platform 120, the shared connections space manager 132, or the virtual meeting manager 142 collects user information (e.g., information about a user's social network, social actions or activities, profession, a user's preferences, or a user's current location), or to control whether or how to receive content from the shared connections space platform 110, the virtual meeting platform 120, the shared connections space manager 132, or the virtual meeting manager 142 that can be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the shared connections space platform 110, the virtual meeting platform 120, the shared connections space manager 132, or the virtual meeting manager 142.

In one or more implementations, a participant can request to create the shared connections space 112. The shared connections space platform 110 can generate the shared connections space 112 on behalf of one or more participants. In some implementations, the shared connections space includes one or more host participants. A host participant may include a participant that has more permissions or privileges regarding the shared connections space 112 than non-host participants. A host participant can invite users to join the shared connections space 112 as participants. In one implementation, the shared connections space 112 may not be accessible by users that have not been invited to join the shared connections space 112. Access to the shared connections space 112 can be controlled using participants'identifying information (e.g., email addresses, names, etc.) or any other similar information. In some implementations, the shared connections space 112 may be joinable by any user. Implementations of the present disclosure can be implemented with any number of participants connecting via the shared connections space 112 (e.g., up to one hundred or more).

In some implementations, the virtual meeting platform 120 enables users of one or more of the client devices 102A-N to connect with each other in a virtual meeting (e.g., a virtual meeting 122). A virtual meeting 122 refers to a real-time communication session such as a video-based call or video chat, in which virtual meeting participants can connect with multiple additional virtual meeting participants in real-time and be provided with audio and video capabilities. A virtual meeting 122 may include an audio-based call or chat, in which virtual meeting participants connect with multiple additional virtual meeting participants in real-time and are provided with audio capabilities. Real-time communication refers to the ability for users to communicate (e.g., exchange information) instantly without transmission delays and/or with negligible (e.g., milliseconds or microseconds) latency. The virtual meeting platform 120 can allow a user of the virtual meeting platform 120 to join and participate in a virtual meeting 122 with other users of the virtual meeting platform 120 (such users sometimes being referred to, herein, as “virtual meeting participants”). Implementations of the present disclosure can be implemented with any number of virtual meeting participants connecting via the virtual meeting 122 (e.g., up to one hundred or more). A virtual meeting participant may, in some cases, be a participant of a shared connections space 112.

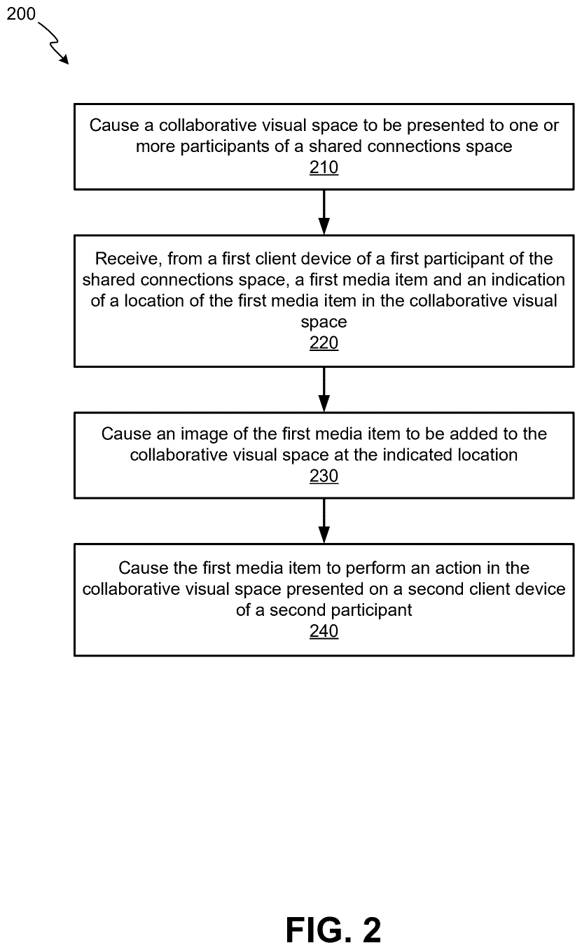

In one or more implementations, the shared connections space server 130 includes a shared connections space manager 132. The shared connections space manager 132, in some implementations, is configured to manage a shared connections space 112 that includes multiple users of the shared connections space platform 110. The shared connections space manager 132 can provide the UIs 105A-N to each client device 102A-N to enable users to view the collaborative visual space 114 and interact with media items included in the collaborative visual space 114. The shared connections space manager 132 can also collect and provide data associated with the shared connections space 112 to each participant of the shared connections space 112. In some implementations, the shared connections space manager 132 provides the UIs 105A-N for presentation by shared connections space applications 104A-N. For example, the respective UIs 105A-N can be displayed on the display devices by the shared connections space applications 104A-N executing on the operating systems of the client devices 102A-N. In some implementations, the shared connections space manager 132 determines images corresponding to media items for presentation in the UIs 105A-N. Further details regarding the shared connections space manager 132 are discussed below in relation to FIG. 2.

In one or more implementations, the shared connections space manager 132 includes a collaborative visual space manager 134. The collaborative visual space manager 134 may include a software application (or a subset thereof) configured to perform certain collaborative visual space functionality. For example, the collaborative visual space manager 134 may be configured to obtain a media item and an indication of the location in the collaborative visual space 114 where an image representing the media item is to be displayed; store the media item and location data; and, responsive to receiving a request from a UI 105A-N of an application 104A-N of a client device 102A-N, retrieve the media item and location data and provide it to the UI 105A-N for displaying the collaborative visual space 114 on the UI 105A-N.

In one implementation, the shared connections space manager 132 includes a text chat manager 136 and an audio chat manager 138. Each of the text chat manager 136 or the audio chat manager 138 may include a software application (or a subset thereof) that performs certain shared connections space functionality for the shared connections space manager 132. The text chat manager 136 may be configured to obtain text data provided by a user to a text chat portion of a UI 105A of a shared connections space shared connections space application 104A of a first client device 102A. The text chat manager 136 can provide the text data to the shared connections space applications 104B-N of other client devices 102B-N of users that belong to the same shared connections space 112 as the first user for display in a text chat portion of UIs 105B-N of the shared connections space applications 104B-N. Thus, the participants of the shared connections space 112 can use the text chat portions of the UIs 105A-N of the shared connections space applications 104A-N to send and receive messages and communicate with each other in real time. Similarly, the audio chat manager 138 may be configured to obtain audio data provided by a user to a shared connections space application 104A of a first client device 102A (e.g., in response to the user interacting with a push-to-talk button of the UI 105A of the shared connections space application 104A and the shared connections space application 104A obtaining audio via a microphone of the client device 102A). The audio chat manager 138 can provide the audio data to the shared connections space applications 104B-N of other client devices 102B-N of users that belong to the same shared connections space 112 as the first user. The shared connections space applications 104B-N can play the audio data (e.g., using speakers of the client devices 102B-N). Thus, the participants of the shared connections space 112 can use the audio chat functionality of the shared connections space applications 104A-N to provide and receive audio and communicate with each other in real time.

In some implementations, the virtual meeting server 140 includes a virtual meeting manager 142. The virtual meeting manager 142, in one or more implementations, is configured to manage a virtual meeting 122 between multiple users of the virtual meeting platform 120. The virtual meeting manager 142 can provide respective virtual meeting UIs to each client device 102A-N to enable users to watch and listen to each other during a virtual meeting 122. The virtual meeting manager 142 can also collect and provide data associated with the virtual meeting 122 to each participant of the virtual meeting 122. In some implementations, the virtual meeting manager 142 determines visual items for presentation in the virtual meeting UIs during a virtual meeting 122. A visual item can refer to a virtual meeting UI element that occupies a particular region in the virtual meeting UI and is dedicated to presenting a video stream from a respective client device. Such a video stream can depict, for example, a user of the respective client device 102A-N while the user is participating in the virtual meeting 122 (e.g., speaking, presenting, listening to other participants, watching other participants, etc., at particular moments during the virtual meeting 122), a physical conference or meeting room (e.g., with one or more participants present), a document or media content (e.g., video content, one or more images, etc.) being presented during the virtual meeting 122, etc.

In some implementations, the virtual meeting manager 142 includes a video stream processor 144 and a UI controller 146. Each of the video stream processor 144 or the UI controller 146 may include a software application (or a subset thereof) that performs certain virtual meeting functionality for the virtual meeting manager 142. The video stream processor 144 may be configured to receive video streams from one or more of the client devices 102A-N. The video stream processor 144 may be configured to determine visual items for presentation in the virtual meeting UIs of such client devices 102A-N during the virtual meeting 122. Each visual item can correspond to a video stream from a client device 102A-N (e.g., the video stream pertaining to one or more participants of the virtual meeting 122). In some implementations, the video stream processor 144 receives audio streams associated with the video streams from the client devices (e.g., from an audiovisual component of the client devices 102A-N). Once the video stream processor 144 has determined visual items for presentation in the virtual meeting UI, the video stream processor 144 can notify the UI controller 146 of the determined visual items. The visual items for presentation can be determined based on current speaker, current presenter, order of the participants joining the virtual meeting 122, list of participants (e.g., alphabetical), etc.

In some implementations, the UI controller 146 provides the virtual meeting UI for the virtual meeting 122. The virtual meeting UI can include multiple regions. Each region can display a video stream pertaining to one or more participants of the virtual meeting 122. The UI controller 146 can control which video stream is to be displayed by providing a command to one or more client devices 102A-N that indicates which video stream is to be displayed in which region of the virtual meeting UI (along with the received video and audio streams being provided to the client devices 102A-N). For example, in response to being notified of the determined visual items for presentation in the virtual meeting UI, the UI controller 146 can transmit a command causing each determined visual item to be displayed in a region of the virtual meeting UI and/or rearranged in the virtual meeting UI.

In some implementations, each of the shared connections space platform 110, the virtual meeting platform 120, the shared connections space server 130, or the virtual meeting server 140 include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that can be used to enable a user to connect with other users via a shared connections space 112 or a virtual meeting 122. The shared connections space platform 110 or the virtual meeting platform 120 can also each include a respective website (e.g., one or more webpages) or application back-end software that can be used to enable a user to connect with other users by way of the shared connections space 112 or the virtual meeting 122 as applicable.

In some implementations, the one or more client devices 102A-N each include one or more computing devices such as personal computers (PCs), laptops, mobile phones, smart phones, tablet computers, netbook computers, network-connected televisions, etc. The one or more client devices 102A-N can also be referred to as “user devices.” Each client device 102A-N can include an audiovisual component. The audiovisual component can generate audio data to be streamed to the shared connections space manager 132. The audiovisual component can generate audio or video data to be streamed to the virtual meeting manager 142. The audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user associated with a particular client device 102A-N. In some implementations, the audiovisual component includes an image capture device (e.g., a camera) to capture images and generate video data (e.g., a video stream) of the captured data of the captured images.

In some implementations, a client device 102A-N can be associated with a physical conference or meeting room. Such client device 102A-N can include or be coupled to a media system that can include one or more display devices, one or more speakers, and one or more cameras. The display device can be, for example, a smart display or a non-smart display (e.g., a display that is not itself configured to connect to the network 160). Users that are physically present in the room can use the media system rather than their own devices (e.g., one or more of the client other devices 102A-N) to participate in the shared connections space 112 or the virtual meeting 122, which can include other remote users. For example, the users in the room that participate in the shared connections space 112 or the virtual meeting 122 can control the display device to show the collaborative visual space 114, a slide presentation, or watch slide presentations of other participants. Sound and/or camera control can similarly be performed.

As described previously, an audiovisual component of each client device 102A-N can capture images and generate video data (e.g., a video stream) of the captured data of the captured images. In some implementations, the client devices 102A-N transmit the generated video stream to the virtual meeting manager 142. The audiovisual component of each client device 102A-N can also capture an audio signal representing speech of a user and generate audio data (e.g., an audio file or audio stream) based on the captured audio signal. In some implementations, the client devices 102A-N transmit the generated audio data to the shared connections space manager 132 or the virtual meeting manager 142.

In some implementations, each client device 102A-N includes a respective shared connections space application 104A-N, which can be a mobile application, a desktop application, a web browser, etc. The shared connections space application 104A-N can present, on a display device of a client device 102A-N, a shared connections space UI (e.g., a UI of the UIs 105A-N), which may include one or more features of the shared connections space application 104A-N for users to access the shared connections space platform 110.

In one or more implementations, each client device 102A-N includes a virtual meeting application 106A-N, which can be a mobile application, a desktop application, a web browser, etc. The virtual meeting application 106A-N can present, on a display device of a client device 102A-N, a virtual meeting UI as discussed above. The users of the virtual meeting applications 106A-N can use the virtual meeting UIs to access one or more features of the virtual meeting platform 120. In some implementations, the shared connections space application 104A-N and the virtual meeting application 106A-N may be a single application on the client device 102A-N.

In one or more implementations, at least a portion of the shared connections space manager 132 and/or at least a portion of the virtual meeting manager 142 are part of a client device 102A-N. For example, the shared connections space application 104A-N can include a portion of the shared connections space manager 132 and/or the virtual meeting application 106A-N an include a portion of the virtual meeting manager 142, which can respectively perform functionality related to the shared connections space 112 or the virtual meeting 122.

In some implementations, the data store 150 is a persistent storage that is capable of storing data as well as data structures to tag, organize, and index the data. A data item can include audio data and/or video stream data, in accordance with implementations described herein. The data store 150 can be hosted by one or more storage devices, such as main memory, magnetic or optical storage-based disks, tapes, hard drives, flash memory, and so forth. In some implementations, the data store 150 is a network-attached file server, while in other implementations, the data store 150 is some other type of persistent storage such as an object-oriented database, a relational database, and so forth, that can be hosted by the shared connections space platform 110, the virtual meeting platform 120, or one or more different machines (e.g., the shared connections space server 130 or the virtual meeting server 140) coupled to the shared connections space platform 110 or the virtual meeting platform 120 using the network 160. In some implementations, the data store 150 stores portions of audio and video streams received from one or more client devices 102A-N for the shared connections space platform 110 or the virtual meeting platform 120. Moreover, the data store 150 can store various types of media items, such as images, audio, videos, text data, links to web resources, or documents (e.g., a slide presentation, a text document, a spreadsheet, or any suitable electronic document (e.g., an electronic document including text, tables, videos, images, graphs, slides, charts, software programming code, designs, lists, plans, blueprints, maps, etc.)).

In some implementations, the network 160 includes a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

It should be noted that in some implementations, the functions of the shared connections space platform 110, the virtual meeting platform 120, the shared connections space server 130, or the virtual meeting server 140 are provided by a fewer number of machines. For example, in some implementations, each of the shared connections space server 130 and the virtual meeting server 140 are respectively integrated into a single machine, while in other implementations, each server 130, 140 is integrated into multiple machines. In addition, in one or more implementations, the shared connections space platform 110 is integrated into the shared connections space server 130. Similarly, the virtual meeting platform 120 may be integrated into the virtual meeting server 140.

In general, one or more functions described in the several implementations as being performed by the shared connections space platform 110, the virtual meeting platform 120, the shared connections space server 130, or the virtual meeting server 140 can also be performed by the client devices 102A-N in other implementations, if appropriate. In addition, in some implementations, the functionality attributed to a particular component can be performed by different or multiple components operating together. The shared connections space platform 110, the virtual meeting platform 120, the shared connections space server 130, or the virtual meeting server 140 can also be accessed as a service provided to other systems or devices through appropriate application programming interfaces, and thus is not limited to use in websites.

Although implementations of the disclosure are discussed in terms of the virtual meeting platform 120 and users of the virtual meeting platform 120 participating in a virtual meeting 122, implementations can also be generally applied to any type of telephone call, conference call, or other technological communications methods between users. Implementations of the disclosure are not limited to virtual meeting platforms that provide virtual meeting tools to users.

FIG. 2 is a flowchart illustrating one embodiment of a method 200 for digital shared connections spaces, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 200 and/or one or more of the method's 200 individual functions, routines, subroutines, or operations. In certain implementations, a single processing thread can perform the method 200. Alternatively, two or more processing threads can perform the method 200, each thread executing one or more individual functions, routines, subroutines, or operations of the method. In an illustrative example, the processing threads implementing the method 200 can be synchronized (e.g., using semaphores, critical sections, and/or other thread synchronization mechanisms). Alternatively, the processing threads implementing the method 200 can be executed asynchronously with respect to each other. Various operations of the method 200 can be performed in a different (e.g., reversed) order compared with the order shown in FIG. 2. Some operations of the method 200 can be performed concurrently with other operations. Some operations can be optional. In some implementations, the shared connections space manager 132 performs one or more of the operations of the method 200.

At block 210, processing logic causes, by a shared connections space platform 110, a collaborative visual space 114 to be presented to one or more participants of a shared connections space 112. The collaborative visual space 114 may include one or more images each representing a media item.

In some implementations, the shared connections space manager 132 causes the collaborative visual space 114 to be presented in response to the one or more participants accessing the shared connections space 112 via respective shared connections space applications 104A-N. Presenting the collaborative visual space 114 to be presented may include a UI 105A-N of a shared connections space application 104A-N of a client device 102A-N displaying the collaborative visual space 114, which may include one or more images that represent respective media items. In one implementation, a media item includes data in a predetermined format that can be visually represented in the collaborative visual space 114.

In one implementation, a media item includes image data. Image data may include an image file or another data format that is renderable as an image on a UI. A media item may include video data. Video data may include a video file, a video stream, or another data format that is renderable as video on a UI. A media item may include audio data. Audio data may include an audio file, an audio stream, or another data format that is playable as audio in a UI.

In some implementations, a media item includes text data. Text data may include one or more text characters, data indicating how the text characters are to be displayed (e.g., a font, a color, a size, kerning data, spacing data, text effects data (e.g., bold, italics, underline, etc.)), or other data associated with displaying text. A media item may include a document. The document may include a document stored on a cloud storage platform. The document may include a slide presentation, a text document, a spreadsheet, or any suitable electronic document (e.g., an electronic document including text, tables, videos, images, graphs, slides, charts, software programming code, designs, lists, plans, blueprints, maps, etc.). A media item may include a link to a web resource stored on a server. The web resource may include a web page, an application (e.g., a web mapping application, an email application, a virtual meeting application, a cloud storage application, or other online applications), a database, or another type of web resource. A web resource may be identified by a Uniform Resource Identifier (URI), an Internet Protocol (IP) address, or another type of identifier.

At block 220, processing logic receives a first media item from a first client device 102A of a first participant of the one or more participants of the shared connections space 112. Processing logic can receive an indication of a location of the first media item in the collaborative visual space 114. Receiving the first media item may include the shared connections space manager 132 obtaining the first media item from the first client device 102A.

In one implementation, the first participant can use a UI 105A of the first client device 102A to provide data associated with the first media item to the shared connections space application 104A, which can then provide the data to the shared connections space manager 132. In some implementations, receiving the first media item includes obtaining a file comprising the first media item. For example, the first participant can use a file selector of the UI 105A to provide a file stored on the client device 102A that contains the first media item to the shared connections space application 104A. Receiving the first media item may include obtaining a link to a web resource, stored on a server, that includes the first media item. For example, the first participant can use a text box of the UI 105A to provide a URI for the first media item to the shared connections space application 104A.

In some implementations, the indication of the location of the first media item in the collaborative visual space 114 may include data indicating a location for the image corresponding to the first media item in the collaborative visual space 114. The data indicating the location may include a set of coordinates, a size of a bounding box, a shape of a bounding box, or other location data. In one implementation, the shared connections space application 104A can obtain the location data responsive to the user of the first client device 102A interacting with the desired location in the collaborative visual space 114 on the UI 105A (e.g., clicking on the location with a mouse cursor, tapping the location on a touch screen, or the like).

At block 230, processing logic causes an image of the first media item to be added to the collaborative visual space 114 at the indicated location. As discussed above regarding block 220, the shared connections space manager 132 can receive the first media item and the indication of the location for the first media item in the collaborative visual space 114. The shared connections space manager 132 can provide the first media item and the indication of the location to the collaborative visual space manager 134. The collaborative visual space manager 134 can store the first media item and the location indication in the data store 150. The data store 150 may include multiple media items, each with respective location data indicating the location of the respective media in the collaborative visual space 114. The first media item and its location indication may be included with the multiple media items of the collaborative visual space 114.

In one implementation, responsive to the first media item being added to the collaborative visual space 114, processing logic provides a notification associated with the first media item to one or more of the participants of the shared connections space 112. Providing the notification may include the shared connections space platform 110, the shared connections space manager 132, or another component of the system 100 providing a push notification to the respective client devices 102A-N of the one or more participants, sending a text message to respective telephone numbers associated with the one or more participants, sending an email to respective email addresses associated with the one or more participants, or sending some other type of notification to the one or more participants.

At block 240, responsive to a second client device 102B of a second participant of the one or more participants accessing the image of the first media item, processing logic causes the first media item to perform an action in the collaborative visual space 114 presented on the second client device 120B of the second participant. In one implementation, the second participant uses the shared connections space application 104B on the second client device 102 to access a UI 105B of the shared connections space application 104B. The UI 105B can display the collaborative visual space 114, which may include the image of the first media item. The participant can use the UI 105B to interact with the image of the first media item (e.g., clicking on the image with a mouse cursor or tapping the image on a touch screen). In response, the collaborative visual space manager 134 can cause the first media item to perform an action.

In one implementation, where the first media item includes audio data, causing the first media item to perform the action in the collaborative visual space 114 includes causing the collaborative visual space 114 to present an audio playback UI element. The audio playback UI element may include a play button, a pause button, an audio seek bar, or other UI elements that the second participant can interact with to control playback of the audio data. In some implementations, receiving the first media item (block 220) includes receiving audio playback configuration data from the first client device 102A. The audio playback configuration data can indicate one or more permissions, for one or more participants of the shared connections space 112, associated with the audio playback UI element. The one or more permissions can indicate which portions of the audio playback UI elements a certain participant can use. For example, the permissions can indicate that (1) a host participant can use the play button, pause button, and the audio seek bar, and (2) a non-host participant can only use the play button and pause button (and cannot use the audio seek bar).

In one or more implementations, where the first media item includes video data, causing the first media item to perform the action in the collaborative visual space 114 includes causing the collaborative visual space 114 to present a video playback UI element. The video playback UI element may include a play button, a pause button, a video seek bar, or other UI elements that the second participant can interact with to control playback of the video data. In some implementations, receiving the first media item (block 220) includes receiving video playback configuration data from the first client device 102A. The video playback configuration data can indicate one or more permissions, for one or more participants of the shared connections space 112, associated with the video playback UI element. The one or more permissions can indicate which portions of the video playback UI elements a certain participant can use. For example, the permissions can indicate that (1) the participant provided the first media item to the collaborative visual space 114 can use the play button, pause button, and the video seek bar, and (2) all other participants can only use the play button and pause button (and cannot use the video seek bar).

In one implementation, where the first media item includes a document stored on a cloud storage platform, causing the first media item to perform the action in the collaborative visual space 114 includes causing the collaborative visual space 114 to present a preview of the document in the collaborative visual space 114. Causing the first media item to perform the action in the collaborative visual space 114 may include causing the second participant's client device 102B to open the document in an application of the client device 102B (e.g., a web browser or a mobile application).

In one or more implementations, where the first media item includes a link to a web resource, causing the image of the first media item to perform the action in the collaborative visual space 114 includes causing the collaborative visual space 114 to present a preview of the web resource in the collaborative visual space 114. Causing the first media item to perform the action in the collaborative visual space 114 may include causing the second participant's client device 102B to open the web resource in an application of the client device 102B (e.g., a web browser or a mobile application).

In some implementations, the shared connections space manager 132 can determine a subset of the one or more participants of the shared connections space 112 that are currently accessing the shared connections space 112. A participant currently accessing the shared connections space 112 may include the shared connections space application 104A-N of the client device 102A-N of the participant (1) presenting the collaborative visual space 114 on the UI 105A-N of the shared connections space application 104A-N, (2) being logged into the shared connections space platform 110, or (3) some other action that allows the participant to readily access the shared connections space 112. The shared connections space manager 132 (including the collaborative visual space manager 134, the text chat manager 136, and/or the audio chat manager 138) can utilize a list of the subset of the one or more participants currently accessing the shared connections space 112 to perform various shared connections space functionality described below.

In one implementation, the shared connections space manager 132 causes a list of the subset of the one or more participants currently accessing the shared connections space 112 to be presented in the collaborative visual space 114 presented on the second client device 102B. The shared connections space manager 132 can provide the list to the second client device 102B, and the UI 105B of the shared connections space application 104B can display the list.

In one implementation, the shared connections space application 104A-N provides text chat functionality for one or more participants currently accessing the shared connections space 112. The text chat functionality of the shared connections space 112 can provide real-time text chat functionality for participants of the shared connections space 112. The shared connections space manager 132 can obtain first text data provided by the second client device 102B. For example, the second participant can interact with a text chat portion of the UI 105B of the shared connections space application 104B of the second client device 102B to input text data, and the shared connections space application 104B can provide the text data as the first text data to the shared connections space manager 132. The shared connections space manager 132 can provide the first text data to the text chat manager 136. The text chat manager 136 can cause the first text data to be provided to one or more client devices 102A-N associated with at least a portion of the subset of the one or more participants currently accessing the shared connections space 112. For example, the text chat manager 136 can provide the first text data to one or more shared connections space applications 104A-N currently accessing the shared connections space 112, and the one or more shared connections space applications 104A-N can display the first text data in a text chat UI of the UIs 105A-N of the one or more shared connections space applications 104A-N.

In one implementation, the shared connections space application 104A-N provides audio chat functionality for one or more participants currently accessing the shared connections space 112. The audio chat functionality of the shared connections space 112 can provide real-time audio chat for participants of the shared connections space 112. The shared connections space manager 132 can obtain first audio data produced by the second client device 102B. For example, the second participant can interact with a “push-to-talk” button of the UI 105B of the shared connections space application 104B of the second client device 102B, speak into a microphone of the second client device 102B, and the shared connections space application 104B can record the second participant's speech as the first audio data. The shared connections space application 104 can provide the first audio data to the shared connections space manager 132. The shared connections space manager 132 can provide the first audio data to the audio chat manager 138. The audio chat manager 138 can determine a subset of the one or more participants of the shared connections space 112 that are currently accessing the shared connections space 112 (e.g., the audio chat manager 138 can obtain the list of the subset of participants from the shared connections space manager 132). The audio chat manager 138 can cause the first audio data to be provided to one or more client devices 102A-N associated with the subset of participants. The one or more shared connections space applications 104A-N of the subset of participants can each obtain the first audio data and can play the first audio data using a speaker of the one or more client devices 102A-N.

In one implementation, the second participant can use the shared connections space 112 to start a virtual meeting 122 between one or more participants of the shared connections space 112. For example, the second participant can interact with a virtual meeting UI element of the UI 105B of the shared connections space application 104B, and the shared connections space application 104B can send data to the shared connections space manager 132 indicating that the second user is interested in starting a virtual meeting 122. The data may include one or more participants of the shared connections space 112 (e.g., the subset of the one or more participants that are currently accessing the shared connections space 112). The shared connections space manager 132 can cause an initialization of a virtual meeting 122 between one or more of the participants of the shared connections space 112 (e.g., one or more participants of the subset of participants currently accessing the shared connections space 112). Causing the initialization of the virtual meeting 122 may include the shared connections space manager 132 sending data to the virtual meeting platform 120, and the virtual meeting platform 120 can use the data to initialize the virtual meeting 122. The virtual meeting manager 142 can send data to the shared connections space manager 132 that the shared connections space manager 132 can use to assist the client devices 102A-N of the participants of the shared connections space 112 to connect to the virtual meeting 122 (e.g., a link to the virtual meeting 122, a passcode used to join the virtual meeting 122, or the like). The shared connections space manager 132 can cause a virtual meeting UI to be presented during the virtual meeting 122. For example, the shared connections space manager 132 can provide the data used to connect to the virtual meeting 122 to the shared connections space applications 104A-N of the participants invited to the virtual meeting 122, and the shared connections space applications 104A-N can each cause a virtual meeting application 106A-N to launch on the client devices 102A-N.

In some implementations, the shared connections space manager 132 obtains, from the virtual meeting 122 between one or more participants, a second media item. The second media item may include a media item shared by a participant of the virtual meeting 122 during the virtual meeting 122. For example, the virtual meeting 122 can provide a text chat feature during the virtual meeting 122, and a first participant may include a link to the second media item in a message of the text chat. In another example, the virtual meeting 122 can provide a screen sharing feature during the virtual meeting 122 where a participant can present the second media item in UI of the virtual meeting application 106A-N. The virtual meeting manager 142 can obtain the second media item from the virtual meeting 122 and can provide the second media item to the shared connections space manager 132. The shared connections space manager 132 can provide the second media item to the collaborative visual space manager 134, which can add the second media item to the collaborative visual space 114.

In some implementations, the shared connections space manager 132 uses artificial intelligence (AI) to generate one or more media items and add those media items to the collaborative visual space 114. The shared connections space manager 132 can obtain one or more media items of the collaborative visual space 114. The shared connections space manager 132 can generate, using an AI model and using the one or more media items as input to the AI model, a second media item. The shared connections space manager 132 can cause an image of the second media item to be added to the collaborative visual space 114.

In one implementation, the AI model includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one implementation, the AI model includes a generative AI model. A generative AI model can deviate from a machine learning model based on the generative AI model's ability to generate new, original data, rather than making predictions based on existing data patterns. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some implementations, the AI model includes an AI model that has been trained on a corpus of data. In some implementations, the AI model can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model to learn broad elements including, image or speech recognition, general sentence structure, common phrases, vocabulary, natural language structure, and other elements. In some implementations, this first, foundational model is trained using self-supervision, or unsupervised training on such datasets.

As indicated above, in some implementations, the AI model includes an LLM. In some implementations, the LLM includes generative AI functionality. In such implementations, the AI model generates new content based on provided input data. The generative AI model can be supported by a prompt subsystem, which can reside on the shared connections space server 130 or may be included with the shared connections space manager 132. The prompt subsystem may be configured to perform automated identification of, and facilitate retrieval of, relevant and timely contextual information for efficient and accurate processing of prompts by the AI model. Using the network 160 (or another network), the prompt subsystem may be in communication with the data store 150, which can store data used by the prompt subsystem. Communications between the prompt subsystem and the shared connections space manager 132 may be facilitated by a generative model application programming interface (API), in some implementations. Communications between the prompt subsystem and the data store 150 may be facilitated by a data management API. In additional or alternative implementations, the generative model API translates prompts generated by the prompt subsystem into unstructured natural-language format and, conversely, translate responses received from the AI model into any suitable form (e.g., including any structured proprietary format as may be used by the prompt subsystem). Similarly, the data management API can support instructions that may be used to communicate data requests to the data store 150 and formats of data received from such components.

In some implementations, the prompt subsystem includes a prompt analyzer to support various operations of this disclosure. For example, the prompt analyzer can receive an input (e.g., a prompt submitted by the shared connections space manager 132) and generate one or more intermediate prompts to the generative AI model to determine what type of data the generative AI model may need to successfully respond to the input. Upon receiving a response from the generative AI model, the prompt analyzer can analyze the response, form a request for relevant contextual data for the data store 150, which can then supply such data. The prompt analyzer can then generate a prompt to the generative AI model that includes the original prompt and the contextual data. In some implementations, the prompt analyzer, itself, includes a lightweight generative AI model that can process the intermediate prompt(s) and determine what type of contextual data may be needed by the generative AI model together with the original prompt to ensure a meaningful response from the generative AI model.

The prompt subsystem may include (or may have access to) instructions stored on one or more tangible, machine-readable storage media of a computing device (e.g., the shared connections space server 130) and executable by one or more processing devices of the computing device. In one implementation, the prompt subsystem is implemented on a single machine. In some implementations, the prompt subsystem is a combination of a client component and a server component.

In one implementation, the generative AI model used by the shared connections space manager 132 to generate media items is trained on a corpus that includes image data, video data, audio data, text data, documents (including slide presentations, text documents, spreadsheets, graphs, charts, software programming code, designs, lists, plans, blueprints, maps, etc.), or web resources. The generative AI model may be configured to output a media item.

As discussed above, in some implementations, the generative AI model uses a prompt as input. The prompt may include one or more media items of the collaborative visual space 114. The prompt subsystem can convert a media item of the one or more media items into a text representation of the media item. For example, the prompt subsystem can convert image data into text describing the image, which may include a title of the image or an author of the image. The prompt subsystem can convert video data into text describing the video data (e.g., the title of the video, the creator of the video, one or more persons or objects that appear in the video, etc.), a transcript of the video data, or other information that describes the video data. The prompt subsystem can convert audio data into text describing the audio (e.g., the title of the audio, an author of the audio, etc.), a transcript of the audio, a description of the non-speech contained in the audio (e.g., a genre of music), or other audio information.

In one or more implementations, the prompt may include a command for the generative AI model to generate a media item that is similar to or relevant to the one or more media items of the collaborative visual space 114 that are used as input. For example, the command may include “Generate an image, video, audio, text, or a document that is relevant to the following:” and the command may be followed by the one or more media items.

In some implementations, the shared connections space manager 132 moves the image of the first media item from its initial location in the collaborative visual space 114 to a different location. The shared connections space manager 132 can receive, from the second client device 102B of the second participant, an indication of a second location for the first media item in the collaborative visual space 114. For example, responsive to the second participant interacting with the UI 105A-N to drag the image of the first media item to a second location in the collaborative visual space, the shared connections space application 104A-N can send an indication of the second location to the shared connections space manager 132. The shared connections space manager 132 can provide the second location to the collaborative visual space manager 134, which can cause the image of the first media item to be moved to the second location in the collaborative visual space. Causing the image of the first media item to be moved may include the collaborative visual space manager 134 updating the location data associated with the first media item to the second location.

In some implementations, the first participant of the shared connections space 112 uses the shared connections space 112 to host an event. The shared connections space manager 132 can receive event data provided by the first participant. The event data may include a date and time. For example, the first participant can enter the event data into the UI 105A of the shared connections space application 104A, and the shared connections space application 104A can provide the event data to the shared connections space manager 132. Responsive to the arrival of the date and time of the event data, the shared connections space manager 132 can provide a notification associated with the event data to one or more of the participants of the shared connections space 112. The notification may include a push notification sent to the client devices 102A-N of the one or more participants, an email sent to the one or more participants, a text message sent to the one or more participants, or some other type of notification.

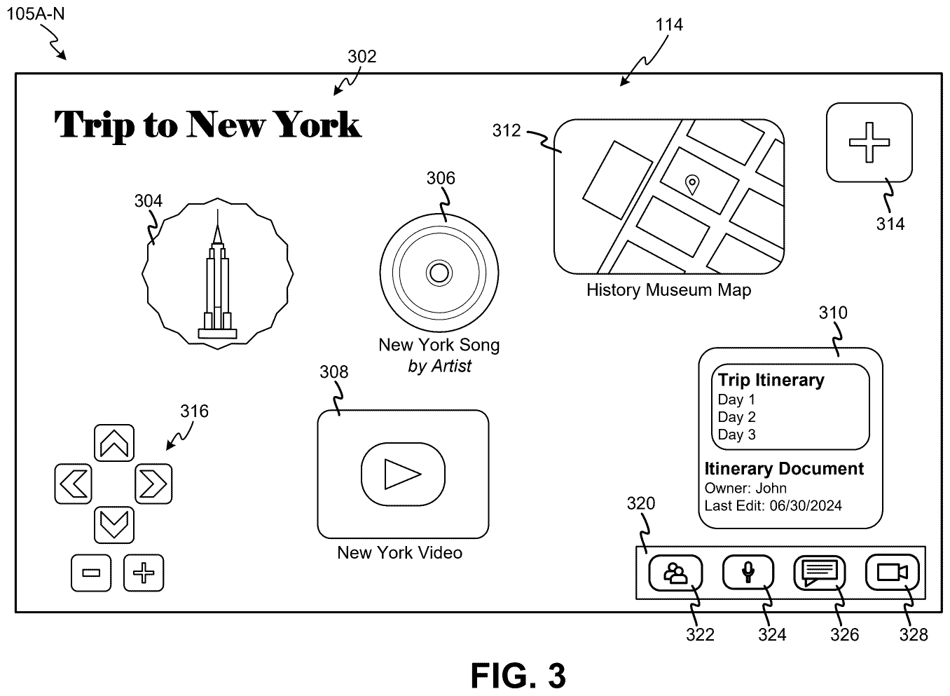

FIG. 3 depicts a UI 105A-N displaying a collaborative visual space 114 of a shared connections space 112, in accordance with some implementations of the present disclosure. The UI 105A-N may be presented on a display device of a client device 102A-N. In one implementation, the UI 105A-N may include the collaborative visual space 114. The collaborative visual space 114 may include a title 302. The title 302 may include text, images, or other data that a participant can view to identify the shared connections space 112.

The collaborative visual space 114 may include one or more images of media items 304-312. For example, the collaborative visual space 114 may include an image 304 corresponding to image data. The collaborative visual space 114 may include an image 306 of audio data. The collaborative visual space 114 may include an image 308 of video data. The collaborative visual space 114 may include an image 310 of a document. The collaborative visual space 114 may include an image 312 of a web resource. A participant can interact with the images 304-312 to cause the media items to perform actions.

The UI 105A-N may include a UI element 314 for adding a media item to the collaborative visual space 114. In one implementation, responsive to a participant interacting with the UI element 314, the UI 105A-N presents a UI element (e.g., a file selector) where the participant can provide a media item for adding to the collaborative visual space 114.

The UI 105A-N may include a navigation UI element 316. The navigation UI element 316 may include UI elements (e.g., buttons) that a participant can interact with to navigate about the collaborative visual space 114. For example, the navigation UI element 316 may include one or more arrow buttons that cause the collaborative visual space 114 to scroll in a certain direction. The navigation UI element 316 may include a zoom-in button or a zoom-out button that cause the UI 105A-N to zoom in or out of the collaborative visual space 114.

In some implementations, the UI 105A-N includes a toolbar 320. The toolbar 320 may include one or more UI elements 322-328 (e.g., buttons) that can present one or more features of the shared connections space application 104A-N. The toolbar 320 may include a participant list UI element 322 that can cause the UI 105A-N to present a list of participants of the shared connections space 112 that are currently accessing the shared connections space 112. The toolbar 320 may include an audio chat UI element 324 (e.g., a push-to-talk button) that can cause the shared connections space application 105A-N to obtain audio data from a microphone of the client device 102A-N and provide the audio data to the audio chat manager 138, as discussed above. The toolbar 320 may include a text chat UI element 326 that can cause the UI 105A-N to display a text chat interface where the participant can input text to be sent to other participants and where the participant can view text sent by other participants, as discussed above. The toolbar 320 may include a virtual meeting launch UI element 328 that can cause the initialization of a virtual meeting 122, as discussed above.

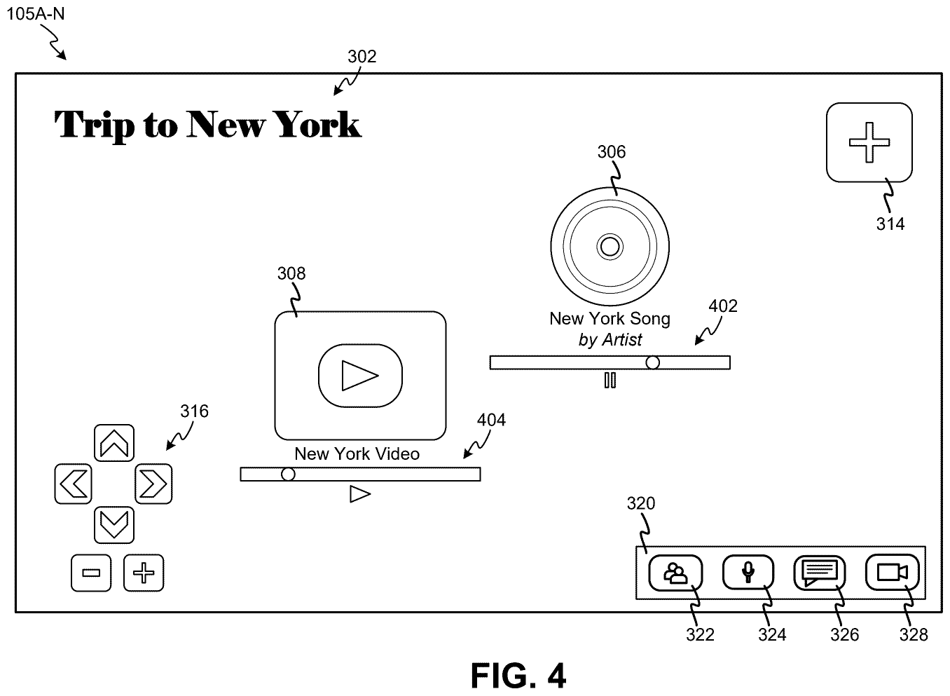

FIG. 4 depicts another UI 105A-N displaying a collaborative visual space 114 of a shared connections space 112, in accordance with some implementations of the present disclosure. In some implementations, responsive to a participant interacting with the image 306 of an audio data media item, the collaborative visual space 114 can display an audio playback UI element 402. Similarly, responsive to the participant interacting with the image 308 of a video data media item, the collaborative visual space 114 can display a video playback UI element 404. Each of the audio playback UI element 402 and the video playback UI element 404 may include UI elements that control playback of the respective audio data and video data (e.g., a play button, a pause button, a seek bar, or the like, as discussed above).

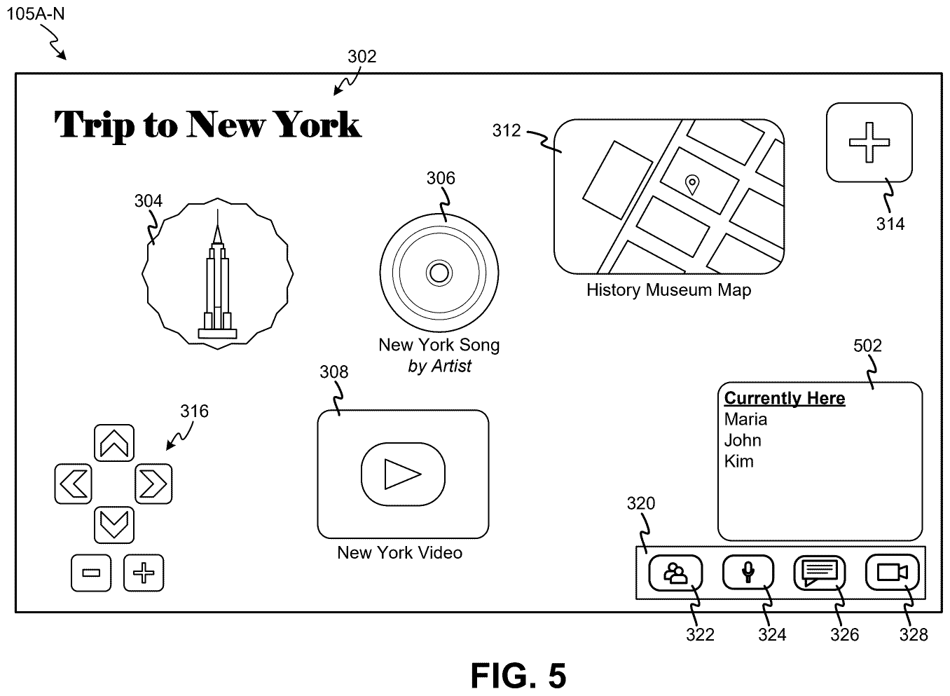

FIG. 5 depicts another UI 105A-N displaying a collaborative visual space 114 of a shared connections space 112, in accordance with some implementations of the present disclosure. The UI 105A-N may include components discussed above in relation to FIG. 3. In one implementation, the UI 105A-N includes a participant list 502. The UI 105A-N can display the participant list 502 responsive to a participant interacting with the participant list UI element 322. The participant list 502 may include text identifying one or more participants of the shared connections space 112 that are currently accessing the shared connections space 112. In one implementation, the participant list 502 can identify all of the participants of the shared connections space 112 but may include a visual indication that identifies the one or more participants that are currently accessing the shared connections space 112.

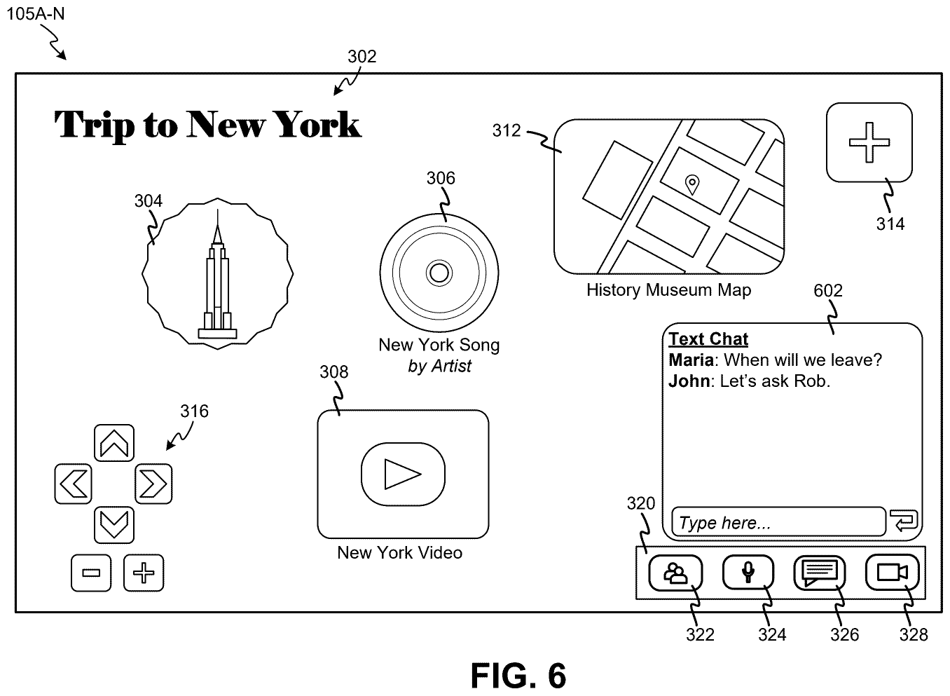

FIG. 6 depicts another UI displaying a collaborative visual space 114 of a shared connections space 112, in accordance with some implementations of the present disclosure. The UI 105A-N may include components discussed above in relation to FIG. 3. In one implementation, the UI 105A-N includes a text chat UI element 602. The text chat UI element 602 can display one or more text-based messages sent by participants of the shared connections space 112 to the text chat manager 136. The text chat UI element 602 may include an input UI element where a participant can enter text data to be sent to the text chat manager 136, as discussed above.

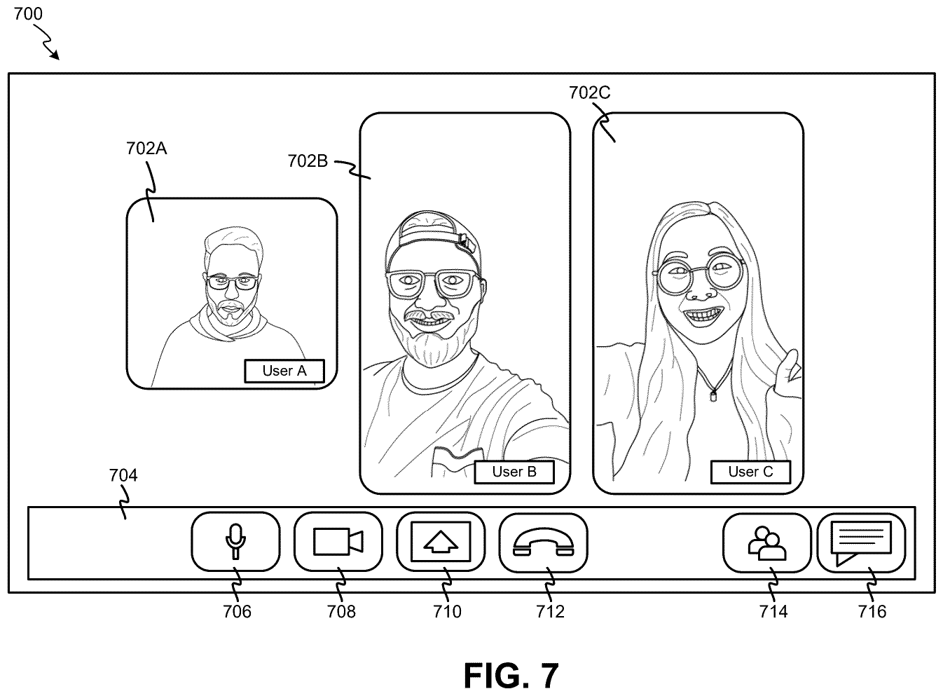

FIG. 7 depicts a virtual meeting UI 700 for a virtual meeting 122 launched from a shared connections space 112, in accordance with some implementations of the present disclosure. Responsive to a participant interacting with the virtual meeting launch UI element 328 of FIG. 3, the virtual meeting platform 120 may initialize the virtual meeting 122, and the shared connections space manager 132 can provide data needed to connect the virtual meeting 122 to the client devices 102A-N. Responsive to the virtual meeting application 106A-N connecting to the virtual meeting 122, the virtual meeting application 106A-N can display the virtual meeting UI 700.

The virtual meeting UI 700 may include one or more regions 702A-C corresponding to a visual item of the virtual meeting 122, such as a video stream provided by a client device 102A-N of a participant of the virtual meeting 122. The virtual meeting UI 700 can include a toolbar 704 that includes one or more UI elements configured to perform virtual meeting operations. For example, as seen in FIG. 7, the toolbar 704 includes an audio control button 706 used to mute and unmute a participant's audio stream, a camera control button 708 used to mute and unmute a participant's video stream, a screen share button 710 used to share a participant's client device's 102A-N screen with other participants of the virtual meeting 122, and a disconnect button 712 used to leave or disconnect from the virtual meeting 122. The toolbar 704 may include a participants button 714 that can display a list of the one or more participants of the virtual meeting 122. The toolbar 704 may include a chat button 716 that can display a chat interface that allows participants of the virtual meeting 122 to send and receive chat messages in the virtual meeting 122.

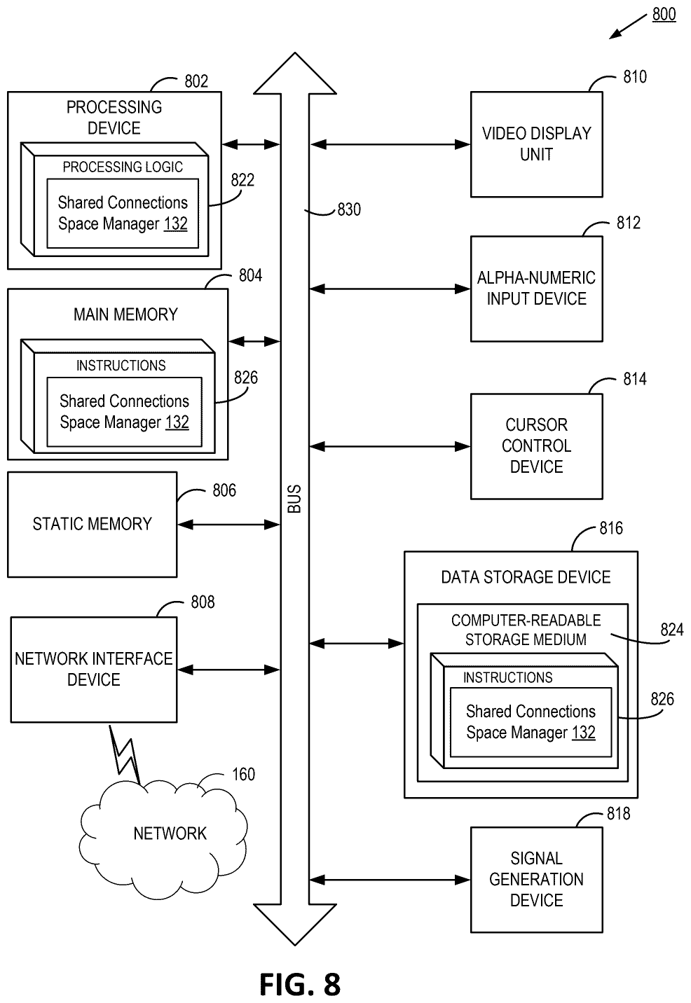

FIG. 8 is a block diagram illustrating an example computer system, in accordance with implementations of the present disclosure. The computer system 800 can include a client device 102A-N, the shared connections space platform 110, the virtual meeting platform 120, the shared connections space server 130, or the virtual meeting server 140 of FIG. 1. The machine can operate in the capacity of a server or an endpoint machine, in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processing device (processor) 802, a main memory 804 (e.g., read-only memory (ROM), flash memory, dynamic random access memory (DRAM) such as synchronous DRAM (SDRAM), double data rate (DDR SDRAM), or DRAM (RDRAM), etc.), a static memory 806 (e.g., flash memory, static random access memory (SRAM), etc.), and a data storage device 816, which communicate with each other via a bus 830.

The processing device 802 represents one or more general-purpose processing devices such as a microprocessor, central processing unit, or the like. More particularly, the processing device 802 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 can also be one or more special-purpose processing devices such as an application specific integrated circuit (ASIC), a field programmable gate array (FPGA), a digital signal processor (DSP), network processor, or the like. The processing device 802 is configured to execute the processing logic 822 for performing the operations discussed herein (e.g., the operations of the shared connections space manager 132).

The computer system 800 can further include a network interface device 808. The computer system 800 also can include a video display unit 810 (e.g., a liquid crystal display (LCD) or a cathode ray tube (CRT)), an input device 812 (e.g., a keyboard, and alphanumeric keyboard, a motion sensing input device, touch screen), a cursor control device 814 (e.g., a mouse), and a signal generation device 818 (e.g., a speaker).

The data storage device 816 can include a non-transitory machine-readable storage medium 824 (sometimes referred to as a “computer-readable storage medium”) on which is stored one or more sets of instructions 826 (e.g., the instructions to carry out one or more operations of the shared connections space manager 132) embodying any one or more of the methodologies or functions described herein. The instructions can also reside, completely or at least partially, within the main memory 804 and/or within the processing device 802 during execution thereof by the computer system 800, the main memory 804 and the processing device 802 also constituting machine-readable storage media. The instructions can further be transmitted or received over the network 160 via the network interface device 808.

In one implementation, the instructions 826 include instructions for determining visual items for presentation in a user interface of a virtual meeting. While the computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” or “an implementation,” means that a particular feature, structure, or characteristic described in connection with the implementation is included in at least one implementation. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method, comprising:
causing, by a shared connections space platform, a collaborative visual space to be presented to a plurality of participants of a shared connections space, the collaborative visual space comprising a plurality of images each representing a media item;
receiving, from a first client device of a first participant of the plurality of participants of the shared connections space, a first media item and an indication of a location of the first media item in the collaborative visual space;
causing an image of the first media item to be added to the collaborative visual space at the indicated location; and
responsive to a second client device of a second participant of the plurality of participants accessing the image of the first media item, causing the first media item to perform an action in the collaborative visual space presented on the second client device of the second participant.

2. The method of claim 1, wherein the first media item comprises at least one of:
image data;
video data; or
audio data.

3. The method of claim 1, wherein the first media item comprises at least one of:
text data;
a document stored on a cloud storage platform; or
a link to a web resource stored on a server.

4. The method of claim 1, wherein receiving the first media item comprises at least one of:
obtaining a file comprising the first media item; or
obtaining a link to a web resource, stored on a server, comprising the first media item.

5. The method of claim 1, further comprising:
determining a subset of the plurality of participants that are currently accessing the shared connections space; and
causing a list of the subset of the plurality of participants to be presented in the collaborative visual space presented on the second client device of the second participant.

6. The method of claim 5, further comprising:
obtaining first text data provided by the second client device; and
causing the first text data to be provided to one or more client devices associated with at least a portion of the subset of the plurality of participants.

7. The method of claim 5, further comprising:
obtaining first audio data produced by the second client device; and
causing the first audio data to be provided to one or more client devices associated with at least a portion of the subset of the plurality of participants.

8. The method of claim 5, further comprising:
causing an initialization of a virtual meeting between at least a portion of the subset of the plurality of participants; and
causing a virtual meeting UI to be presented during the virtual meeting.

9. The method of claim 1, wherein responsive to the first media item being added to the collaborative visual space, the method further comprises providing a notification associated with the first media item to at least a portion of the plurality of participants.

10. The method of claim 1, further comprising:
generating, using an artificial intelligence (AI) model and using one or more media items of the collaborative visual space as input to the AI model, a second media item; and
causing an image of the second media item to be added to the collaborative visual space.

11. A system, comprising:
a memory; and
a processing device, coupled to the memory, configured to perform operations comprising:
causing, by a shared connections space platform, a collaborative visual space to be presented to a plurality of participants of a shared connections space, the collaborative visual space comprising a plurality of images each representing a media item;
receiving, from a first client device of a first participant of the plurality of participants of the shared connections space, a first media item and an indication of a location of the first media item in the collaborative visual space;
causing an image of the first media item to be added to the collaborative visual space at the indicated location; and
responsive to a second client device of a second participant of the plurality of participants accessing the image of the first media item, causing the first media item to perform an action in the collaborative visual space presented on the second client device of the second participant.

12. The system of claim 11, wherein:
the first media item comprises audio data;
causing the first media item to perform the action in the collaborative visual space comprises causing the collaborative visual space to present an audio playback UI element; and
receiving the first media item comprises receiving audio playback configuration data indicating one or more permissions, for the plurality of participants, associated with the audio playback UI element.

13. The system of claim 11, wherein:
the first media item comprises video data;
causing the first media item to perform the action in the collaborative visual space comprises causing the collaborative visual space to present a video playback UI element; and
receiving the first media item comprises receiving video playback configuration data indicating one or more permissions, for the plurality of participants, associated with the video playback UI element.

14. The system of claim 11, wherein the operations further comprise:
receiving, from the second client device of the second participant, an indication of a second location for the first media item in the collaborative visual space; and
causing the image of the first media item to be moved to the second location in the collaborative visual space.

15. The system of claim 11, wherein the operations further comprise:
obtaining, from a virtual meeting between at least a portion of the plurality of participants, a second media item, wherein the second media item includes a media item shared by a participant of the at least a portion of the plurality of participants during the virtual meeting; and
adding the second media item to the collaborative visual space.

16. The system of claim 11, further comprising:
receiving, at the shared connections space platform, event data provided by the first participant, wherein the event data comprises a date and time;
responsive to an arrival of the date and time of the event data, providing a notification associated with the event data to at least a portion of the plurality of participants.

17. The system of claim 11, wherein the first media item comprises at least one of:
image data;
video data;
audio data;
text data;
a document stored on a cloud storage platform; or
a link to a web resource stored on a server.

18. A non-transitory computer-readable storage medium comprising instructions that, when executed by a processing device, cause the processing device to perform operations comprising:
causing, by a shared connections space platform, a collaborative visual space to be presented to a plurality of participants of a shared connections space, the collaborative visual space comprising a plurality of images each representing a media item;
receiving, from a first client device of a first participant of the plurality of participants of the shared connections space, a first media item and an indication of a location of the first media item in the collaborative visual space;
causing an image of the first media item to be added to the collaborative visual space at the indicated location; and
responsive to a second client device of a second participant of the plurality of participants accessing the image of the first media item, causing the first media item to perform an action in the collaborative visual space presented on the second client device of the second participant.

19. The computer-readable storage medium of claim 18, wherein the first media item comprises at least one of:
image data;
video data;
audio data;
text data;
a document stored on a cloud storage platform; or
a link to a web resource stored on a server.

20. The computer-readable storage medium of claim 18, further comprising:
causing an initialization a virtual meeting between at least a portion of the plurality of participants of the shared connections space; and
causing a virtual meeting UI to be presented during the virtual meeting.
